(19) United States
(12) Patent Application Publication
(10) Pub. No.: US 2003/0222431 A1
(43) Pub. Date: Dec. 4, 2003

(54) Reconfigurable trailer

(76) Inventors: Welton Crosby, Kooskia, ID (US); Joseph Schranz, Kooskia, ID (US)

Correspondence Address: David R. McKinney, THORPE, NORTH & WESTERN, L.L.P., P.O. Box 1219, Sandy, UT, 84091-1219, US

(21) Appl. No.: 10/256,819

(22) Filed: Sep. 27, 2002

Related U.S. Application Data
(60) Provisional application No. 60/384,037, filed on May 28, 2002.

(51) Int. Cl. B62B 1/00

(52) U.S. Cl. 280/656

(57) ABSTRACT

A highway and off-road trailer with folding sides that is selectively reconfigurable as a box trailer for towing behind a powered vehicle, and as a flatbed trailer that is suitable for carrying the powered vehicle for towing behind another vehicle.

The present application claims priority from U.S. Provisional Patent Application Serial No. 60/384,037, filed on May 28, 2002, and entitled RECONFIGURABLE TRAILER.

### BACKGROUND OF THE INVENTION

1. Field of the Invention

The present invention is related generally to utility trailers for motor vehicles. More particularly, the present invention relates to a highway and off-road trailer that is reconfigurable as both a cargo trailer which may be towed behind an ATV, and as a highway trailer for carrying the ATV for towing behind another vehicle.

2. Related Art

There are many types of utility trailers. Some are general purpose trailers designed for carrying cargo of various kinds. Such trailers typically have a box configuration, much like the bed of a pickup truck. There are also specialized trailers for towing sport and recreational vehicles, such as motorcycles, snowmobiles, all-terrain vehicles (ATV's), etc. Many of these are basic flatbed trailers that may also include stake pockets, hold-down hardware, etc. While some types of general cargo can be carried by either a box trailer or a flatbed trailer, most flat-bed trailers cannot be used for many types of cargo. For example, sand, gravel, and other bulk granular materials cannot be effectively carried on a flatbed trailer. On the other hand, snowmobiles cannot generally be disposed transversely in the bed of a box trailer. Carrying in this manner requires a flatbed without sides.

Convertible trailers of various kinds have been developed for accommodating various types of cargo. However, these usually involve removable side panels and other bulky parts that must be stored when not in use. Other convertible trailers involve complicated size or shape changing mechanisms that are costly and present maintenance headaches.

With the increasing popularity of ATV's, small utility trailers have also been created for towing behind an ATV. However, these trailers are generally very small, and not suitable for general use with larger vehicles. They also present the same usefulness problems that other utility trailers present, as mentioned above. Additionally, an ATV is usually towed behind another vehicle to the area where it will be used. It is difficult to tow the ATV on one trailer, and also carry along another trailer for use by the ATV. Nevertheless, there are many situations where having a trailer for separate use by the ATV is desirable. Yet existing trailers are not designed to be towed by the recreational vehicle they are designed to carry. Likewise, most conventional cargo trailers are not suitable for towing or being towed by an ATV.

### SUMMARY OF THE INVENTION

It has been recognized that it would be advantageous to develop a trailer that can carry a vehicle, can also be used for many types of cargo, and can also be towed by the vehicle it is designed to carry.

The invention advantageously provides a trailer that is reconfigurable as both a box trailer that is towable behind a powered vehicle, and as a flatbed trailer for carrying the powered vehicle for towing behind another vehicle. The trailer includes front, side, and rear panels that fold down from an upright position to the flatbed configuration.

In accordance with a more detailed aspect of the invention, the trailer includes corner extension panels hingedly connected to their adjacent panels. These panels slide into pockets when the trailer is folded into the box configuration, and slide out of those pockets to provide a support surface in the corner spaces between the side panels and the front and rear panels, respectively when in the lowered position.

In accordance with another more detailed aspect of the invention, the trailer includes removable side extensions that connect to the side panels, and are also usable as loading ramps.

In accordance with yet another more detailed aspect of the invention, the invention provides a trailer that is tiltable on its frame, to accommodate loading and unloading cargo.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a side perspective view of one embodiment of a reconfigurable trailer in accordance the present invention, with the trailer in the fully closed box configuration and hitched to a four wheel ATV.

FIG. 2 is a side perspective view of the trailer of FIG. 1 with the rear panel lowered and the trailer tipped backward.

FIG. 3 is a rear corner perspective view of the trailer of FIG. 1 with the trailer in the fully open flatbed configuration and the loading ramp members attached to the lowered rear panel.

FIG. 4 is a front corner perspective view of the trailer in the flatbed configuration, with the side extensions attached and the four wheel ATV loaded thereon for towing by another vehicle.

FIG. 5 is a partial cross-sectional view showing the hinged connection of a side panel to the trailer frame.

FIG. 6 is a partial cross-sectional view of an alternative configuration of the hinged connection of a side panel to the trailer frame having an extensible frame support member.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one skilled in the relevant art and having possession of this disclosure, are to be considered within the scope of the invention.

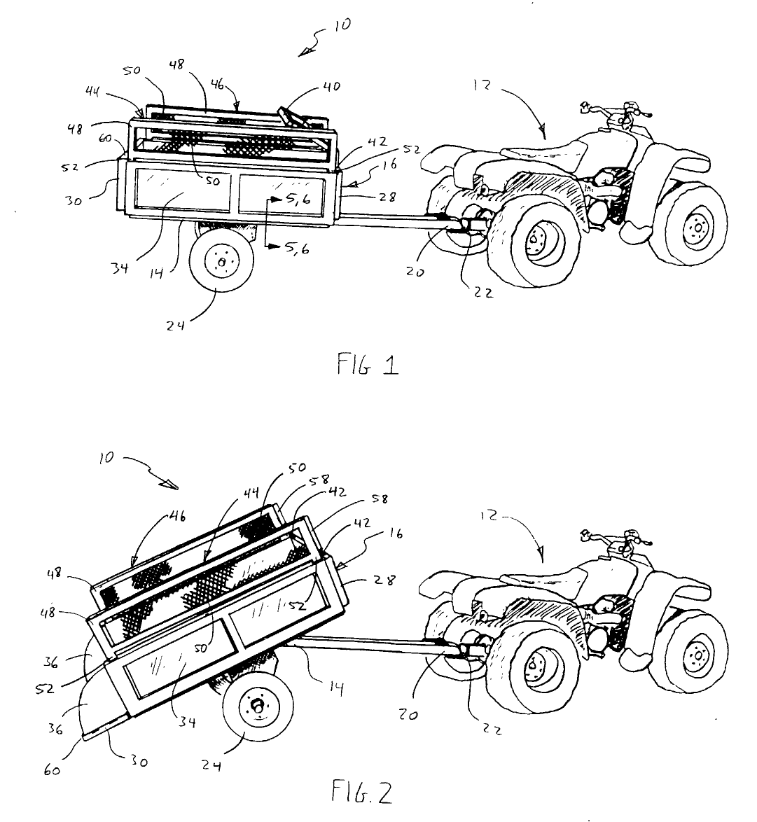

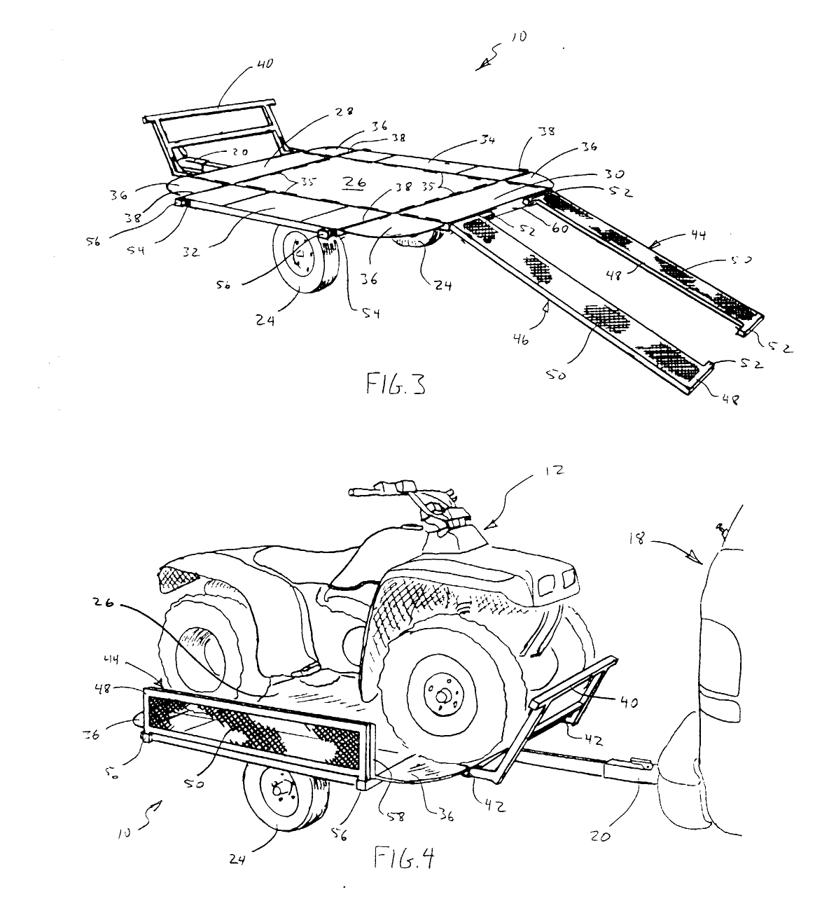

Referring to FIG. 1, the invention advantageously provides a reconfigurable highway and off-road trailer 10 that is configured for towing behind a powered vehicle, such as a four wheel ATV 12. The trailer generally comprises a trailer frame 14, and a trailer body 16. The trailer body is selectively reconfigurable between a box configuration, shown in FIG. 1, and a flatbed configuration, shown in FIG. 3. In the box configuration, the trailer has a width approximately equal to that of the four wheel ATV. In the flatbed configuration, the trailer is suitable—i.e. long enough, wide enough and strong enough—for carrying the ATV itself, as shown in FIG. 4, for towing behind another powered vehicle 18, such as a truck or car.

It will be apparent that the powered vehicle for towing and being towed upon the trailer need not be an ATV, but could be any of a wide variety of vehicles. For example, the trailer can be configured for supporting and carrying a full size automobile or truck for pulling behind another (presumably larger) vehicle. The general concept is a trailer having a first small size and configuration for pulling behind a powered vehicle, and a second larger size and configuration suitable for supporting the powered vehicle for pulling behind another vehicle.

The trailer frame 14 includes a hitch mechanism—i.e. a tongue 20—configured to connect to a hitch 22 of the towing vehicle (the ATV 12 or truck 18), and wheels 24 for supporting the trailer. The trailer body generally comprises a substantially planar trailer bed 26 (best viewed in FIG. 3) supported on the trailer frame above the wheels. Hingedly connected to the trailer bed are a front panel 28, a rear panel 30, and side panels 32 and 34. These panels are moveable from an upright position that is substantially perpendicular to the trailer bed (the box configuration of FIG. 1), to a lowered position that is substantially coplanar with the trailer bed (the flatbed configuration of FIG. 3). In the upright position, the side, front and rear panels are connected to each other by pins, clips, latches, or any other device suitable for securely connecting them together. The panels themselves thus hold each other in the upright position. The trailer body is advantageously tiltably connected to its frame, as depicted in FIG. 2. This feature facilitates use of the trailer for dumping cargo, such as dirt, gravel, and other bulk materials.

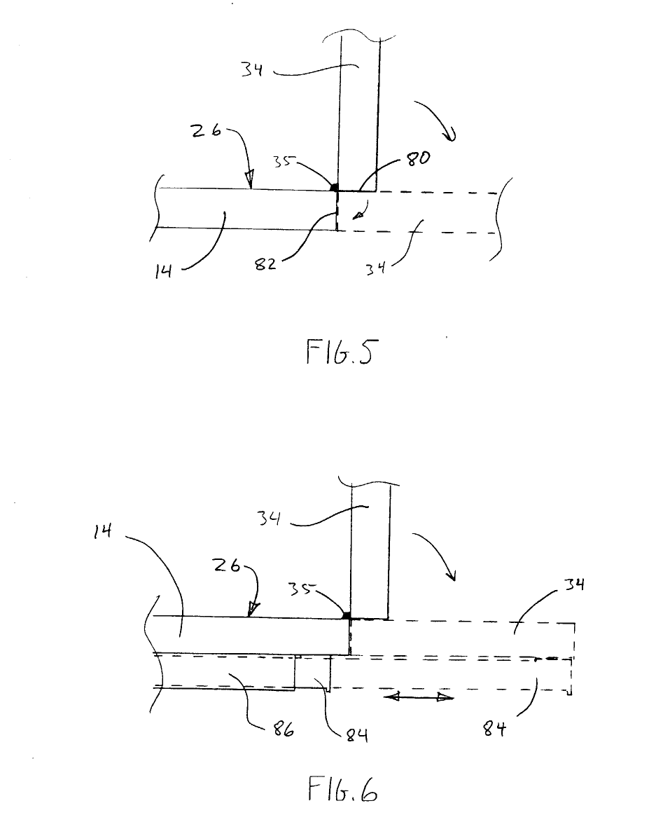

In the configuration depicted in FIGS. 1-4, the front, rear, and side panels are connected to the trailer bed via a substantially continuous hinge 35 along their length. A cross-sectional view showing the hinged connection of a side panel 34 to the trailer frame 14 and bed 26 is provided in FIG. 5. While a side panel is depicted, the configuration shown applies to the front, rear, and side panels. As depicted in FIG. 5, when one of the hinged panels is rotated to its lowered position, shown in dashed lines, the abutment of the lower face 80 of the moveable panel against the side edge 82 of the support frame provides the support structure for the lowered panel. The panels themselves and the hinged connection are designed to have sufficient strength so that the trailer, including the lowered panel, can support the weight of a vehicle thereatop.

Alternatively, the support structure for the lowered panels may include additional members. As shown in FIG. 6, the trailer frame 14 may include an extensible frame support member 84 which can be extended to provide additional support to the lowered panel 34. When not in use, the extensible frame support member telescopically retracts into a sleeve 86 that is attached to the lower side of the trailer frame. In the extended position, shown in dashed lines, the extensible frame support member provides additional support for loads that may be imposed on the lowered panel, beyond what the simple hinged connection of FIG. 5 can provide. For example, where the trailer is intended to support a relatively heavy vehicle in its flatbed configuration, it may be impractical to configure the side panels with sufficient strength to support the size of vehicle that is intended using the simple hinge connection. Such panels may be too heavy for a user to manually raise or lower. Consequently, where expected loads are large, the front rear and side panels can be lighter in weight, yet still provide adequate support via the extensible frame support member 84.

Referring to FIG. 3, disposed in the corner spaces between the lowered front 28, rear 30, and side panels 32 and 34 are corner extension panels 36. These corner panels are substantially planar semi-circular pieces of steel that have an approximately quarter-circle shape, with one circularly curved edge, and two substantially straight edges that are perpendicular to each other. These panels are hingedly connected along one straight edge to the near edge of the adjacent front or rear panel, respectively. When the trailer is in the folded-up box configuration, the corner panels are disposed within pockets 38 disposed on the inside of the adjacent side panels and helps lock the side panels and front and rear panels in the upright position. However, when the front, rear, and side panels are lowered, the corner panels slide out of the pockets, and fold down into place to provide a support surface that is substantially coplanar with the trailer bed in the corner spaces between the side panels and front and rear panels. When in the folded out position, a portion of one straight edge of the corner panel 36 stays near the pocket 38 so as to be supported by that region of the side panel, while the other straight edge is supported by the hinge connection to the edge of the front or rear panel, respectively.

It will be apparent that the corner extension panels could be configured in other ways. For example, rather than being hingedly attached to the front and rear panels 28 and 30 and sliding into pockets 38 disposed on the side panels 32 and 34, the corner panels 36 could alternatively be hingedly connected to the side panels and fit within pockets on the front and rear panels. As another alternative configuration, rather than pockets 38, the corner extension panels could include an arcuate slot disposed parallel to the semicircular outside edge of the panel, and which is configured to slide over a bolt, pin, or bracket that is affixed on the side panel. When in the upright position, the bolt or pin holds the corner extension panel against the corresponding side panel, while its hinges hold it to the front or rear panel. However, when the front or rear panel is lowered, the slot of the corner panel slides along the pin or bolt until the fully lowered position is reached. The slot may be configured with an end that acts as a stop against the bolt or pin when the fully lowered position is reached.

The design shown in the figures allows either the front or rear panels to be lowered without also lowering the side panels. For example, viewing FIG. 2, the rear panel can be lowered like a tailgate for access to the trailer bed, or to dump trailer contents. The front panel may be similarly lowered. In such a configuration, the corner panels are vertically oriented, providing a side panel in the space between the horizontal front or rear panel and the vertical side panels. This can be helpful in containing material when dumping dirt or gravel, for example. Alternatively, with the rear panel lowered and the side panels upright, the trailer can be used to haul logs or other long items, yet contain them within the side panels.

Associated with the front panel 28 is a front extension member 40 that is removably connectable to the front panel, both when that panel is in the upright position and when it is in the lowered position. As depicted herein, the front extension member is a bent frame of tubular steel members that slidably fits into stake pockets 42 disposed in the top edge of the front panel. When the front panel is in the upright position, as depicted in FIG. 1, the bent frame extension member extends partially over the trailer bed 26. This configuration can be desirable to hold down cargo in the trailer, and also helps hold the vertical side extensions in place when the trailer is empty. However, the extension member is removable from the stake pockets, and need not be present with the trailer in the box configuration, as shown in FIG. 2. Referring to FIGS. 3 and 4, when the front panel 28 is in the lowered position, the extension member 40 extends forwardly and upwardly from the (now horizontal) front panel, providing a forward stop for the front wheels 40 of the ATV when it is disposed on the trailer.

Associated with the side panels 32 and 34 are side extensions 44, 46 that are removably connectable to the side panels both when the side panels are in the upright position and when the side panels are in the lowered position. The side extensions generally comprise a rectangular frame 48 with a steel mesh center panel 50 (such as expanded metal) and lower legs 52 extending from the frame. The side panels are configured such that the side extensions may be vertically oriented when the side panels are in either the upright or lowered position. When the side panels are in the upright position, the lower legs 52 of the side panels slide into upright stake pockets 54 located in the upper edges of the side panels, as shown in FIG. 1. However, when the side panels are in the lowered position, the lower legs of the side extensions fit into flatbed stake pockets 56 that are connected to the edge of the side panels and oriented transversely to the upright stake pockets, as shown in FIG. 4. In both configurations, the side extensions are designed to increase the utility of the trailer by helping to hold cargo within. When inserted into their respective stake pockets, the side extensions and front extension member may be secured in place with clips, latches, pins, or any other suitable device to prevent them from becoming unsecured during use.

The side extensions also serve an additional purpose. The removable side extensions 44, 46 are strong enough and have the right shape and size to be used as loading ramps for the trailer, as shown in FIG. 3. As shown in FIGS. 2 and 4, the side extension frames 48 include an end flange 58 that is connectable to the outboard edge 60 of the rear panel 30 when that panel is lowered. Thus, the side extensions form loading ramps that can be used for many purposes, including that of driving a four-wheel ATV onto the trailer bed, as shown in FIG. 4. The center panel 50, being steel mesh or expanded metal, advantageously provides a high friction surface that also allows material, such as dirt and debris, to drop through, rather than build up upon it. Once cargo is loaded or unloaded to or from the trailer, the side extensions can be removed from their loading ramp position, and again connected to the side panels. This configuration thus provides lightweight extensions for the side panels to help contain cargo, and also provides loading ramps with a convenient storage location.

The present invention thus provides a trailer with several different configurations. In a folded-up configuration the trailer is a cargo trailer with front, back, and lateral side walls, and steel mesh vertical side extensions for containing higher loads. The rear wall or panel drops down like a tailgate for easy loading and unloading, and the entire trailer body tilts backwardly on its frame for dumping. The front and lateral side walls also drop down like the back panel in various combinations. The front panel includes an upwardly angled frame which helps hold down cargo, helps hold the vertical side extensions in place when the trailer is empty, and which may be removed entirely if desired.

The trailer also has a folded-out flatbed configuration to form a flatbed trailer. The steel mesh vertical side extensions are removably connectable to the back panel to function as loading ramps for loading cargo, including the vehicle that tows the trailer. The side extensions can then be reattached to the lateral side walls in a different orientation as sidewalls for the flatbed. Also in the flatbed configuration, the angled frame associated with the front wall becomes a stop for the front wheels of a vehicle disposed on the trailer, or for other cargo.

In the flatbed configuration of the depicted embodiment, the trailer is large enough and strong enough (approx. 1000 lb capacity) to carry nearly all varieties of four-wheel ATV's, yet is small enough and light enough to be towed behind relatively small automobiles (i.e., those smaller than a pickup truck). The trailer can also be used to carry motorcycles, snowmobiles, or other vehicles or items, or in a larger embodiment could be configured to carry larger vehicles. However, in the folded-up configuration, the embodiment of the trailer shown is approximately as narrow as the ATV itself, and thus may be towed and used by the ATV. It also has relatively high ground clearance (approx. 1 ft.), which makes it useful in off-road applications.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A reconfigurable trailer, comprising:
a) a trailer frame, having a hitch mechanism configured to connect to a towing vehicle, and wheels for supporting the trailer;
b) a substantially planar trailer bed, supported on the trailer frame and above the wheels, and having a front, a rear, and sides;
c) side panels, hingedly connected to the sides of the trailer bed, and moveable from an upright position that is substantially perpendicular to the trailer bed, to a lowered position that is substantially coplanar with the trailer bed;
d) wherein the trailer is (i) configured to be towed behind a first powered vehicle when the side panels are in the upright position, and (ii) configured for carrying the first vehicle for towing behind a second vehicle when the side panels are in the lowered position; and
e) support structure, associated with the trailer frame and capable of bearing weight of the first vehicle applied to the side panels in the lowered position.

2. A reconfigurable trailer in accordance with claim 1, further comprising a front panel, hingedly connected to the front of the trailer bed, and a rear panel, hingedly connected to the rear of the trailer bed, the front and rear panels being moveable from an upright position that is substantially perpendicular to the trailer bed, to a lowered position that is substantially coplanar with the trailer bed.

3. A reconfigurable trailer in accordance with claim 2, further comprising a front extension member, removably connectable to the front panel when in the upright position and when in the lowered position.

4. A reconfigurable trailer in accordance with claim 3, wherein the front extension member comprises a frame configured to (i) extend at least partially over the trailer bed when the front panel is in the upright position, and (ii) extend upward from the front panel when the front panel is in the lowered position, providing a forward stop for front wheels of the first vehicle when said first vehicle is disposed on the trailer.

5. A reconfigurable trailer in accordance with claim 2, further comprising loading ramps that are (i) removably connectable to the rear panel when in the lowered position when in use as loading ramps, and (ii) removably connectable to the trailer when not in use as loading ramps.

6. A reconfigurable trailer in accordance with claim 5, wherein the loading ramps comprise side extensions that are removably connectable to the side panels in an upright orientation (i) when the side panels are in the upright position and (ii) when the side panels are in the lowered position.

7. A reconfigurable trailer in accordance with claim 2, further comprising moveable corner extension panels, disposed in corner spaces between (i) the side panels and the rear panel, and (ii) the side panels and the front panel, configured to provide a support surface in said corner spaces when the trailer is in the flatbed configuration.

8. A reconfigurable trailer in accordance with claim 7, wherein the corner extension panels are hingedly connected to the front and rear panels, respectively, and are slidably disposable within pockets disposed on an inside of adjacent side panels when adjacent front or rear and side panels are in the upright position.

9. A reconfigurable trailer in accordance with claim 1, wherein the support structure further comprises an extensible frame support member, attached to the trailer frame, and configured to extend outwardly therefrom to support the side panels when in the lowered position.

10. A reconfigurable trailer in accordance with claim 1, further comprising side extensions that are removably connectable to the side panels in an upright orientation (i) when the side panels are in the upright position and (ii) when the side panels are in the lowered position.

11. A reconfigurable trailer in accordance with claim 1, wherein the trailer bed is tiltably connected to the trailer frame.

12. A reconfigurable trailer, comprising:
a) a trailer frame, having a hitch mechanism for connecting to a towing vehicle, and wheels for supporting the trailer; and
b) a trailer body, disposed on the trailer frame, having a bed, a front panel, and side panels;
c) the front and side panels being hingedly connected to the bed and moveable between (i) an upright position, wherein the trailer assumes a box configuration, having a width approximately equal to that of a first powered vehicle, and suitable for towing behind the first vehicle, and (ii) a lowered position, substantially coplanar with the bed, wherein the trailer assumes a flatbed configuration suitable for carrying the first vehicle while being towed behind a second vehicle, at least the front and side panels having sufficient strength to support the weight of the first vehicle when in the lowered position.

13. A reconfigurable trailer in accordance with claim 12, further comprising:
a) a rear panel hingedly connected to the bed; and
b) moveable corner extension panels, disposed in corner spaces between (i) the side panels and the rear panel, and (ii) the side panels and the front panel, configured to provide a support surface in said corner spaces when the trailer is in the flatbed configuration.

14. A reconfigurable trailer in accordance with claim 12, further comprising a front extension member, removably connectable to the front panel in the upright position, and in the lowered position.

15. A reconfigurable trailer in accordance with claim 12, wherein the trailer bed is tiltably connected to the trailer frame.

16. A reconfigurable trailer in accordance with claim 12, further comprising side extensions, removably connectable to the side panels in an upright orientation (i) when the side panels are in the upright position and (ii) when the side panels are in the lowered position.

17. A reconfigurable trailer in accordance with claim 16, wherein the side extensions are further configured to be removably connectable to the rear panel when in the lowered position, for use as loading ramps.

18. A reconfigurable trailer in accordance with claim 12, wherein the front, rear, and side panels are removably connected to the trailer bed.

19. A reconfigurable highway and off-road trailer, comprising:
a. a trailer frame; and
b. a trailer body, having a substantially planar trailer bed, the trailer body being reconfigurable between:
i. a box configuration, having at least three sides, with a width approximately equal to that of a first powered vehicle and suitable for towing behind the first vehicle; and
ii. a flatbed configuration, wherein at least two of the three sides are adjusted to an orientation that is substantially coplanar with the trailer bed, and suitable for carrying the first vehicle while being towed behind a second vehicle.

20. A reconfigurable trailer in accordance with claim 19, wherein the trailer body is tiltably connected to the trailer frame.
